(19) United States
(12) Patent Application Publication
(10) Pub. No.: US 2020/0093102 A1
(43) Pub. Date: Mar. 26, 2020

(54) HIVE TOOL

(71) Applicant: Jason Gouedy, Loranger, LA (US)

(72) Inventor: Jason Gouedy, Loranger, LA (US)

(21) Appl. No.: 16/579,074

(22) Filed: Sep. 23, 2019

Related U.S. Application Data
(60) Provisional application No. 62/735,274, filed on Sep. 24, 2018.

(51) Int. Cl. A01K 55/00; B25J 1/04

(52) U.S. Cl. CPC A01K 55/00; B25J 1/04

(57) ABSTRACT

A hive tool is provided which may be used to pry apart or separate two objects, such as an upper hive body from a lower hive body of a bee hive. The tool may include a handle, having a handle axis, and a blade coupled to the handle. The blade may include a lifting surface angled relative to the handle axis. A nose may join the lifting surface with a first lower surface. A first upper surface may be positioned between the lifting surface and a first stop surface. A second upper surface may be positioned between the first stop surface and the handle. A catch surface may be positioned between the first lower surface and a second lower surface, and the second lower surface may be positioned between the catch surface and the handle.

### CROSS REFERENCE TO RELATED APPLICATIONS

This application claims priority to and the benefit of the filing date of U.S. Provisional Application No. 62/735,274, filed on Sep. 24, 2018, entitled “HIVE TOOL”, which is hereby incorporated by reference in its entirety.

### FIELD OF THE INVENTION

This patent specification relates to the field of bee keeping tools. More specifically, this patent specification relates to a tool which may be used to manipulate bee hive bodies or boxes.

### BACKGROUND

To open the top of a bee hive or to separate the hive bodies or boxes, a tool must be used. All parts of the hive are firmly secured together, by the honey bees, using propolis, which is a sticky substance made by honey bees.

The tool used for this is commonly known as a hive tool. Generally, a hive tool is a device that is pushed between the hive bodies/boxes to separate two surfaces. The reason for separating the parts of the hive include inspection, honey extraction and smoking the hive. For all of these tasks, the hive tool must remain in the beekeeper's hand leaving only the other hand to manipulate the hive, smoker or other tools. Have only one free hand available to perform these tasks is a problem faced by bee keepers and workers.

Therefore, a need exists for novel bee keeping tools. There is also a need for novel tools which may be used to manipulate bee hive bodies or boxes. A further need exists for novel bee keeping tools which may be used to manipulate bee hive bodies or boxes while allowing the beekeeper to use both hands for bee keeping performing tasks.

### BRIEF SUMMARY OF THE INVENTION

A hive tool is provided which may be used to pry apart or separate two objects, such as an upper hive body from a lower hive body of a bee hive. In some embodiments, the tool may include a handle, having a handle axis, and a blade coupled to the handle. The blade may include a lifting surface angled relative to the handle axis. A nose may join the lifting surface with a first lower surface. A first upper surface may be positioned between the lifting surface and a first stop surface. A second upper surface may be positioned between the first stop surface and the handle. A catch surface may be positioned between the first lower surface and a second lower surface, and the second lower surface may be positioned between the catch surface and the handle.

In still further embodiments, a receding surface may be positioned between the second lower surface and the handle.

In yet further embodiments, a second stop surface may be positioned between the second upper surface and the handle.

Generally, a user may grip the handle to insert the blade between two adjacent hive bodies or boxes so that the lifting surface and first lower surface may separate the adjacent hive bodies or boxes. The blade may be further inserted so that the upper hive body may rest on a desired upper surface, while the second lower surface may rest on the lower hive body to support the weight of the upper hive body and tool, thereby maintaining a separation between the upper hive body and the lower hive body of a bee hive.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of an example of a hive tool according to various embodiments described herein.

FIG. 2 illustrates a first side elevation view of an example of a hive tool according to various embodiments described herein.

FIG. 3 shows a second side view of another example of a hive tool according to various embodiments described herein.

FIG. 4 depicts a perspective view of an example of a hive tool being used to separate elements of a bee hive according to various embodiments described herein.

FIG. 5 illustrates another side elevation view of an example of a hive tool according to various embodiments described herein.

FIG. 6 shows a further side elevation view of an example of a hive tool according to various embodiments described herein.

FIG. 7 depicts still another side elevation view of an example of a hive tool according to various embodiments described herein.

FIG. 8 illustrates a side elevation view of another example of a hive tool according to various embodiments described herein.

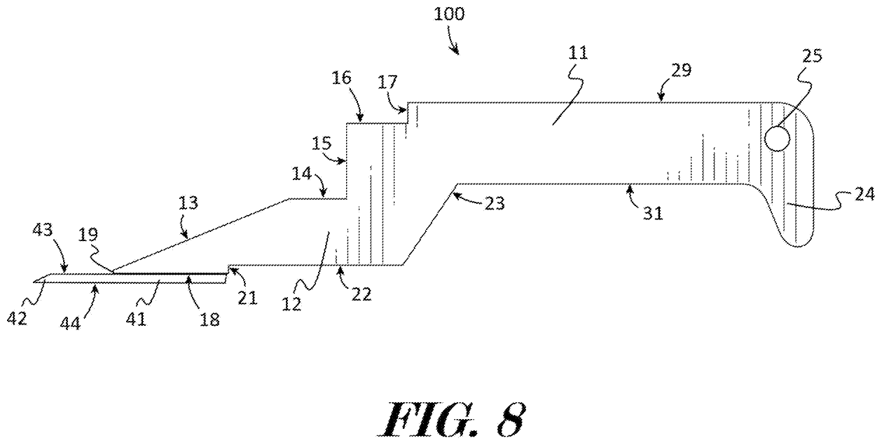

FIG. 9 shows a perspective view of another example of a hive tool according to various embodiments described herein.

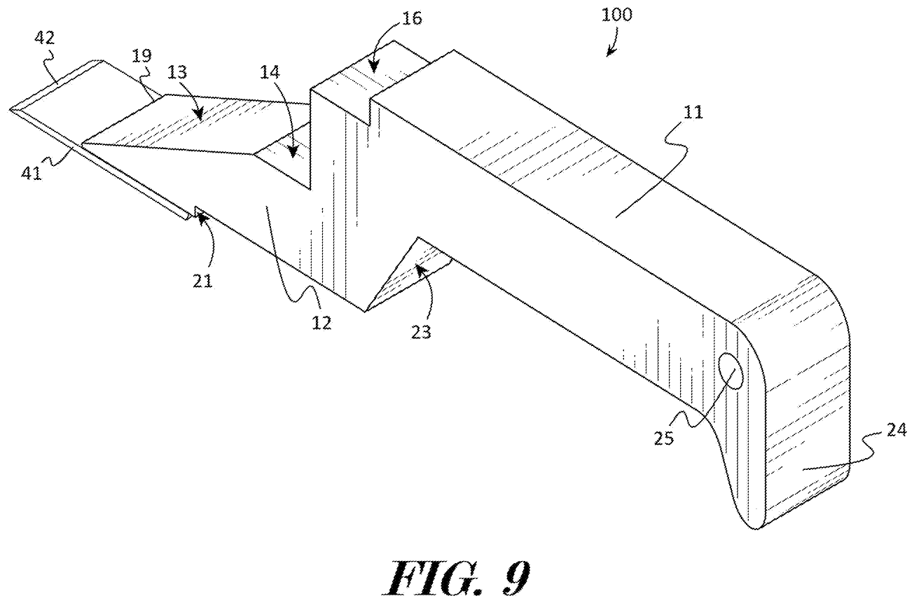

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

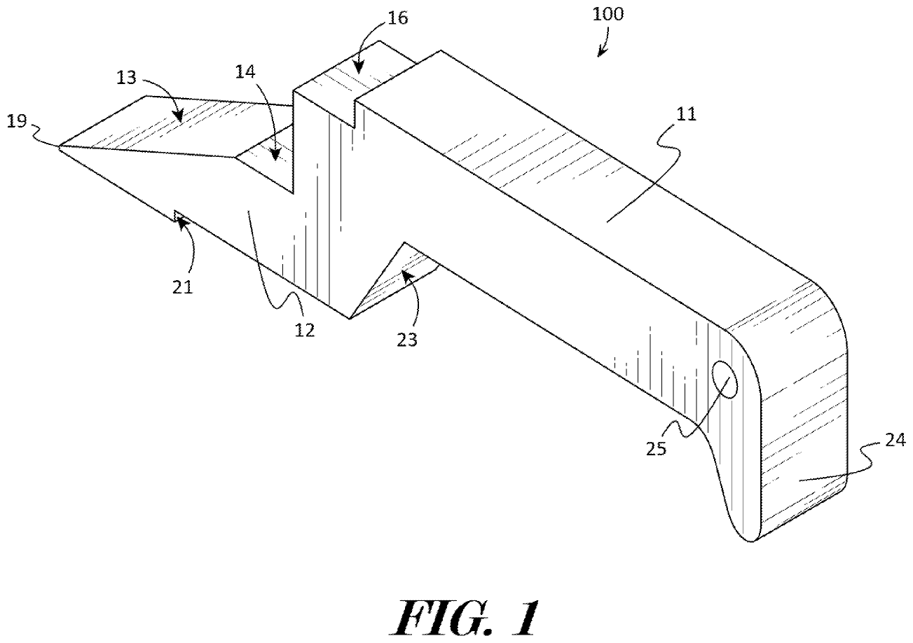

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts of the invention. Hence, specific dimensions and other physical characteristics relating to the embodiments disclosed herein are not to be considered as limiting, unless expressly stated otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new bee keeping tool is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

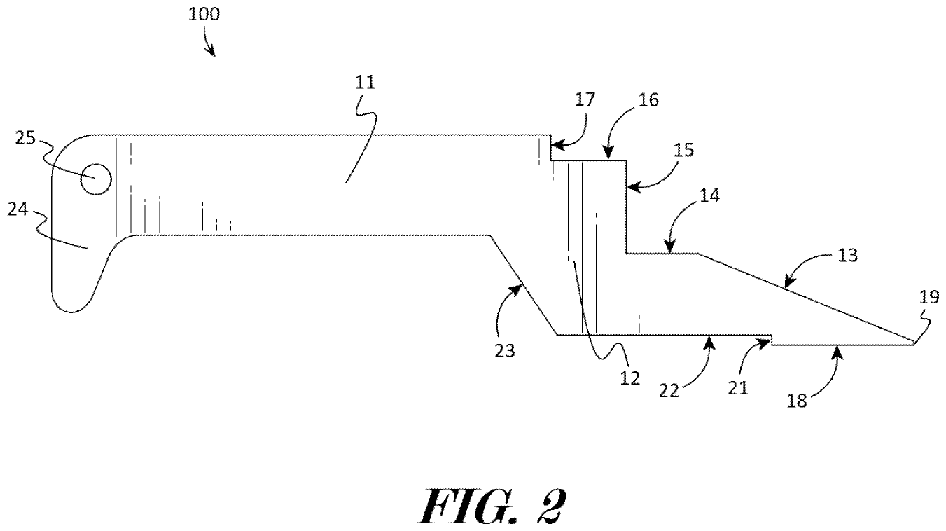

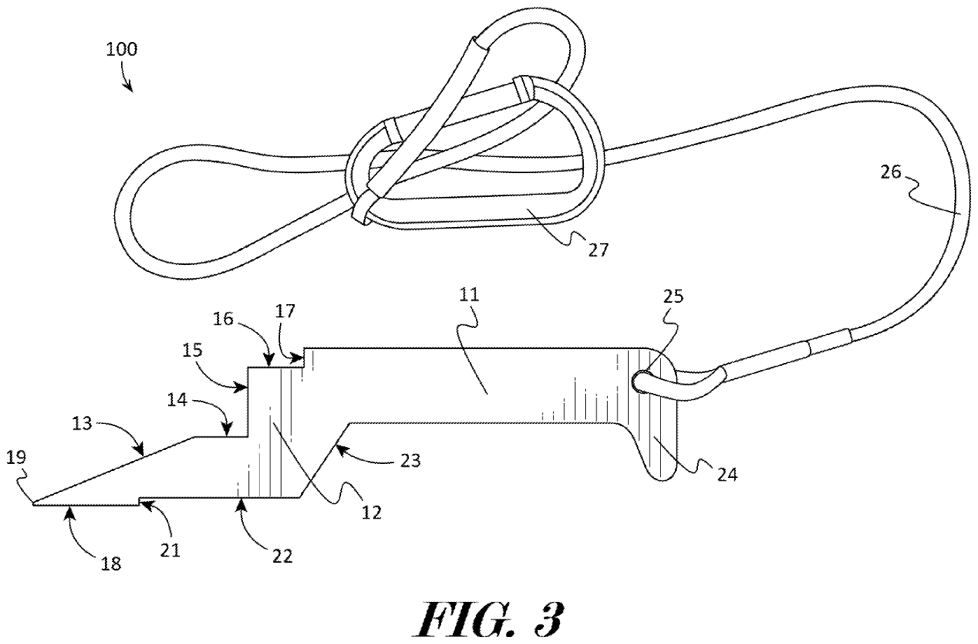

The present invention will now be described by example and through referencing the appended figures representing preferred and alternative embodiments. FIGS. 1-4 illustrate examples of a hive tool (“the tool”) 100 according to various embodiments. In some embodiments, the tool 100 may comprise a handle 11 which may be coupled to a blade 12. The blade 12 may include a lifting surface 13 that may be angled relative to the handle 11. A first upper surface 14 may be coupled to the lifting surface 13 and to a first stop surface 15. The first stop surface 15 may also be coupled to a second upper surface 16. A second stop surface 17 may couple the second upper surface 16 to the handle 11. The lifting surface 13 may intersect with a first lower surface 18 at a nose 19. The first lower surface 18 may be coupled to a catch surface 21, and the catch surface 21 may also be coupled to a second lower surface 22. The second lower surface 22 may also be coupled to a receding surface 23, and the receding surface 23 may also be coupled to the handle 11.

In further embodiments, the tool 100 may comprise a handle 11, having a handle axis 28, and a blade 12 coupled to the handle 11. The blade 12 may include a lifting surface 13 angled relative to the handle axis 28. A nose 19 may join the lifting surface 13 with a first lower surface 18. A first upper surface 14 may be positioned between the lifting surface 13 and a first stop surface 15. A second upper surface 16 may be positioned between the first stop surface 15 and the handle 11. A catch surface 21 may be positioned between the first lower surface 18 and a second lower surface 22, and the second lower surface 22 may be positioned between the catch surface 21 and the handle 11. In still further embodiments, a receding surface 23 may be positioned between the second lower surface 22 and the handle 11. In yet further embodiments, a second stop surface 17 positioned between the second upper surface 16 and the handle 11.

Generally, a user may grip the handle 11 to insert the blade 12 between two adjacent hive bodies or boxes 201, 202, so that the lifting surface 13 and first lower surface 18 may separate the adjacent hive bodies or boxes 201, 202. The blade 12 may be further inserted so that the upper hive body 202 may rest on a desired upper surface 14, 16, while the second lower surface 22 may rest on the lower hive body 201 to support the weight of the upper hive body 202 and tool 100, thereby maintaining a separation between the upper hive body 202 and the lower hive body 201 of a bee hive 200.

In some embodiments, the handle 11 and/or blade 12 may be made from or may comprise a substantially rigid material, such as steel alloys, aluminum, aluminum alloys, copper alloys, other types of metal or metal alloys, ceramics such as alumina, porcelain, and boron carbide, earthenware, natural stone, synthetic stone, various types of hard plastics, such as polyethylene (PE), Ultra-high-molecular-weight polyethylene (UHMWPE, UHMW), polypropylene (PP) and polyvinyl chloride (PVC), polycarbonate, nylon, Poly(methyl methacrylate) (PMMA) also known as acrylic, melamine, hard rubbers, fiberglass, carbon fiber, resins, such as epoxy resin, wood, other plant based materials, or any other material including combinations of materials that are substantially rigid and suitable for supporting the weight of one or more hive bodies or boxes 201, 202. In further embodiments, the handle 11 and/or blade 12 may be made from or may comprise a flexible material, such as natural and/or synthetic rubber material such as latex rubber, silicone foam, silicone rubber, rubber foam, urethane foam, plastic foam, neoprene foam, latex foam rubber, polyurethane foam rubber, forms of the organic compound isoprene, Polyacrylate Rubber, Ethylene-acrylate Rubber, Polyester Urethane, flexible plastics, such as high-density polyethylene (HDPE), polyvinyl chloride (PVC), polypropylene (PP), Polystyrene (PS), Polycarbonate (PC), low density polyethylene (LDPE), natural or synthetic fabric, or any other flexible material including combinations of materials.

The tool 100 may comprise a handle 11 which may be gripped or held by a user. In some embodiments, a handle 11 may comprise a generally elongated prism shape. In other embodiments, a handle 11 may comprise a generally cylindrical shape. In other embodiments, a handle 11 may comprise any shape which may be suitable for being held and manipulated by the hand of a user. Optionally, the handle 11 may comprise texturing, finger notches or depressions, or any other surface feature which may facilitate the ability of a user to grasp the handle 11.

In some embodiments, a handle 11 may comprise a handle axis 28 which may substantially define the central axis around which a user may grasp the handle 11 so that when the handle is grasped by a user, extend approximately centrally in the hand between the fingers, thumb, and palm. Preferably, a handle 11 may comprise an upper handle surface 29 and a lower handle surface 31, and a handle axis 28 may extend between the upper handle surface 29 and lower handle surface 31. In some embodiments, the tool 100 may comprise a lifting surface 13, nose 19, and first lower surface 18 that may each be positioned below the handle axis 28. In further embodiments, the tool 100 may comprise a second lower surface 22 and/or a receding surface 23 that may be positioned below the handle axis 28.

In some embodiments, a handle 11 may comprise a pommel 24 which may be opposingly positioned to the blade 12. Generally, a pommel 24 may comprise a protrusion which may prevent the user's hand from slipping off of the handle 11 away from the blade 12. In further embodiments, a handle 11 may comprise an aperture 25 which may extend partially or fully through the handle 11. Optionally, an aperture 25 may comprise a round shape or any other shape. In preferred embodiments, the tool 100 may comprise an overall length of between approximately 5.0 to 24 inches, and more preferably between approximately 7.0 to 15 inches, and still more preferably between approximately 8.0 to 10 inches as measured from nose 19 to the portion of the pommel 24 most distal to the nose 19, although the tool 100 and any of its elements discussed herein may be configured with any dimensions.

In some embodiments, the tool 100 may comprise a lanyard 26 which may be coupled to the handle 11. Preferably, an aperture 25 may be shaped to receive portions of the lanyard 26 and used to couple the lanyard 26 to the handle 11 although other coupling methods may be used. A lanyard 26 may be made of rope, string, chain, fabric, braided wire, solid wire, or any other material which preferably may be flexible.

In some embodiments, the tool 100 may comprise a retainer 27 which may be used to couple the tool to other objects, such as to the clothing of a user. Preferably, a retainer 27 may comprise a carabiner or clip type fastener. In other embodiments, a retainer 27 may comprise a clip, clasp, clamp, hook-and-loop type fasteners, or any other removable fastener.

The blade 12 and handle 11 may be coupled together with any suitable device or method. In some embodiments, the blade 12 and handle 11 may be integrally formed or molded together. In other embodiments, the blade 12 and handle 11 may be may be coupled together with one or more fasteners, such as screws, bolts, and other threaded fasteners, rivets, adhesive, heat welding or bolding, or any other fastening method.

In some embodiments, the blade 12 may include a lifting surface 13 that may be used to pry apart two objects, such as by lifting an upper hive body 202 away from a lower hive body 201. In some embodiments, a lifting surface 13 may be angled relative to the handle 11, such as by being angled below the handle 11. In further embodiments, a lifting surface 13 may be angled relative to a lower surface 18, 22, such as by being angled by approximately 10 to 45 degrees above a lower surface 18, 22. Preferably, a lifting surface 13 may be generally flat or planar in shape and/or contour. In preferred embodiments, a lifting surface 13 comprise a generally planar rectangular prism shape. In alternative embodiments, a lifting surface 13 may be curved, such as by being convex curved or concave curved, or configured with any other contour. In further alternative embodiments, a lifting surface 13 may be circular in shape, triangular in shape, ovoid in shape, or configured with any other shape.

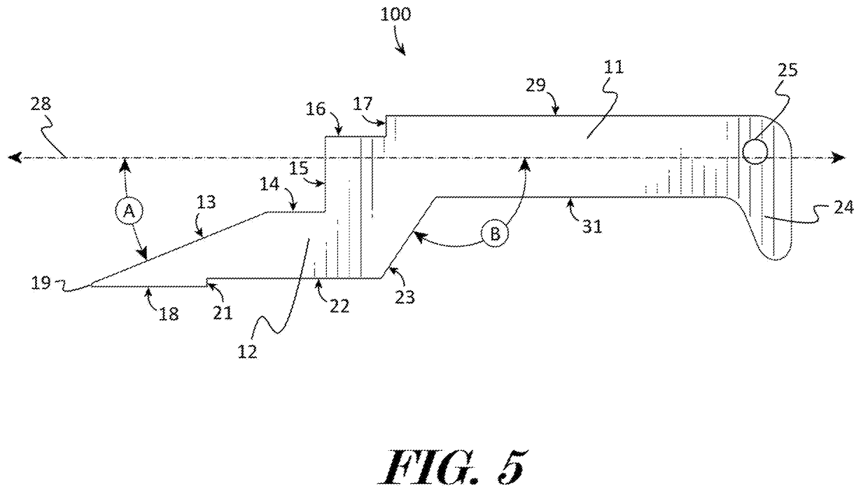

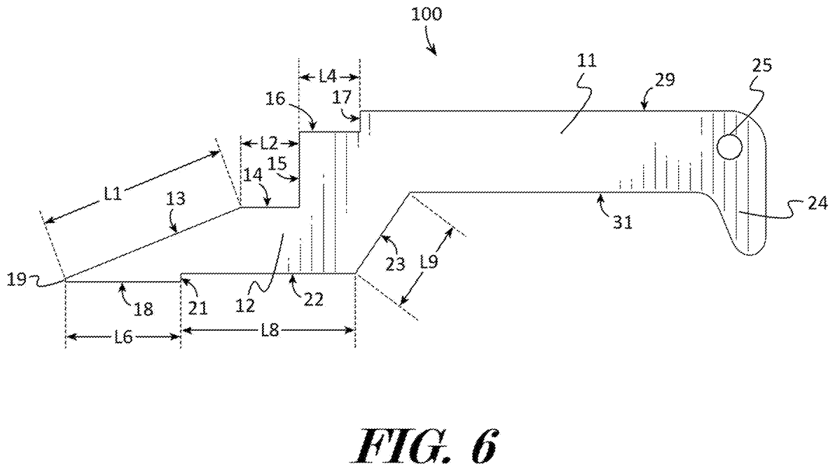

In further embodiments, a lifting surface 13 may be angled relative to the handle axis 28 by being angled below the handle axis 28 as shown by angle A (FIG. 5). Preferably, Angle A may be between 15 and 15 degrees, and more preferably between 20 and 40 degrees. In further embodiments, a lifting surface 13 may comprise a first length dimension (L1) as shown in FIG. 6, and L1 may be between approximately 1.5 and 5.0 inches, and more preferably between approximately 1.9 and 2.6 inches.

The tool 100 may comprise a first upper surface 14 that may be positioned between the lifting surface 14 and the handle 11. In some embodiments, a first upper surface 14 may be coupled to the lifting surface 13 and to a first stop surface 15, preferably so that the lifting surface 13 and first stop surface 15 are separated by the first upper surface 14. Generally, a first upper surface 14 may be configured to support portions of an object, such as an upper hive body 202, when the tool 100 is inserted between two objects, such as a lower hive body 201 and an upper hive body 202. In some embodiments, the first upper surface 14 may be approximately parallel to the handle 11, second upper surface 16, first lower surface 18, and/or second lower surface 22. In further embodiments, the first upper surface 14 may be approximately perpendicular to the first stop surface 15, second stop surface 17 and/or catch surface 21. Preferably, a first upper surface 14 may be generally flat or planar in shape. In alternative embodiments, a first upper surface 14 may be curved, such as by being convex curved or concave curved, or configured with any other shape.

Preferably, a first upper surface 14 may be generally flat or planar in shape and/or contour. In preferred embodiments, a first upper surface 14 may comprise a generally planar rectangular prism shape. In alternative embodiments, a first upper surface 14 may be curved, such as by being convex curved or concave curved, or configured with any other contour. In further alternative embodiments, a first upper surface 14 may be circular in shape, triangular in shape, ovoid in shape, or configured with any other shape. In further embodiments, a first upper surface 14 may comprise a second length dimension (L2) as shown in FIG. 6, and L2 may be between approximately 0.25 and 1.0 inches, and more preferably between approximately 0.4 and 0.6 inches.

The tool 100 may comprise a first stop surface 15 that may be positioned between the first upper surface 14 and the handle 11. In some embodiments, a first stop surface 15 may be coupled to the first upper surface 14 and to a second upper surface 16 so that the first upper surface 14 and second upper surface 16 are separated by the first stop surface 15. Generally, a first stop surface 15 may be configured to rest against exterior portions of an object, such as an upper hive body 202, when the first upper surface 14 of the tool 100 is inserted between two objects, such as a lower hive body 201 and an upper hive body 202. In some embodiments, the first stop surface 15 may be approximately perpendicular to the handle 11, first upper surface 14, second upper surface 16, first lower surface 18, and/or second lower surface 22. In further embodiments, the first stop surface 15 may be approximately parallel to the second stop surface 17 and/or catch surface 21.

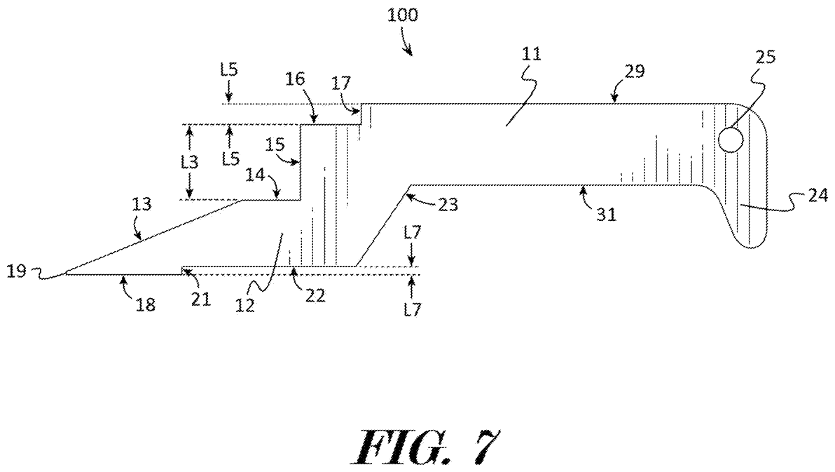

Preferably, a first stop surface 15 may be generally flat or planar in shape and/or contour. In preferred embodiments, a first stop surface 15 may comprise a generally planar rectangular prism shape. In alternative embodiments, a first stop surface 15 may be curved, such as by being convex curved or concave curved, or configured with any other contour. In further alternative embodiments, a first stop surface 15 may be circular in shape, triangular in shape, ovoid in shape, or configured with any other shape. In further embodiments, a first stop surface 15 may comprise a third length dimension (L3) as shown in FIG. 7, and L3 may be between approximately 0.25 and 1.75 inches, and more preferably between approximately 0.8 and 1.2 inches.

The tool 100 may comprise a second upper surface 16 that may be positioned between the first stop surface 15 and the handle 11. In some embodiments, a second upper surface 16 may be coupled to the first stop surface 15 and to a second stop surface 17, preferably so that the first stop surface 15 and second stop surface 17 are separated by the second upper surface 16. Generally, a second upper surface 16 may be configured to support portions of an object, such as an upper hive body 202, when the first upper surface 14 and first stop surface 15 of the tool 100 are inserted between two objects, such as a lower hive body 201 and an upper hive body 202. In some embodiments, the second upper surface 16 may be approximately parallel to the handle 11, first upper surface 14, first lower surface 18, and/or second lower surface 22. In further embodiments, the second upper surface 16 may be approximately perpendicular to the first stop surface 15, second stop surface 17 and/or catch surface 21.

Preferably, a second upper surface 16 may be generally flat or planar in shape and/or contour. In preferred embodiments, a second upper surface 16 may comprise a generally planar rectangular prism shape. In alternative embodiments, a second upper surface 16 may be curved, such as by being convex curved or concave curved, or configured with any other contour. In further alternative embodiments, a second upper surface 16 may be circular in shape, triangular in shape, ovoid in shape, or configured with any other shape. In further embodiments, a second upper surface 16 may comprise a fourth length dimension (L4) as shown in FIG. 6, and L4 may be between approximately 0.25 and 1.75 inches, and more preferably between approximately 0.55 and 0.95 inches.

The tool 100 may comprise a second stop surface 17 that may be positioned between the second upper surface 16 and the handle 11. In some embodiments, a second stop surface 17 may be coupled to the second upper surface 16 and to the handle 11 so that the second upper surface 16 and handle 11 are separated by the second stop surface 17. Generally, a second stop surface 17 may be configured to rest against exterior portions of an object, such as an upper hive body 202, when the second upper surface 16 of the tool 100 is inserted between two objects, such as a lower hive body 201 and an upper hive body 202. In some embodiments, the second stop surface 17 may be approximately perpendicular to the handle 11, first upper surface 14, second upper surface 16, first lower surface 18, and/or second lower surface 22. In further embodiments, the second stop surface 17 may be approximately parallel to the first stop surface 15 and/or catch surface 21.

Preferably, a second stop surface 17 may be generally flat or planar in shape and/or contour. In preferred embodiments, a second stop surface 17 may comprise a generally planar rectangular prism shape. In alternative embodiments, a second stop surface 17 may be curved, such as by being convex curved or concave curved, or configured with any other contour. In further alternative embodiments, a second stop surface 17 may be circular in shape, triangular in shape, ovoid in shape, or configured with any other shape. In further embodiments, a second stop surface 17 may comprise a fifth length dimension (L5) as shown in FIG. 7, and L5 may be between approximately 0.05 and 0.5 inches, and more preferably between approximately 0.15 and 0.35 inches.

In some embodiments, the tool 100 may comprise a nose 19 which may be formed at the intersection of the lifting surface 13 and a first lower surface 18. Generally, a nose 19 may form an edge or bevel which may be narrow so as to ease the insertion of the tool 100 between two objects, such as a lower hive body 201 and an upper hive body 202. In some embodiments, a nose 19 may be configured with a flat shape. In other embodiments, a nose 19 may be configured with a rounded shape, angled or beveled shape, spear shape, or any other shape which may facilitate the insertion of the lifting surface 13 and first lower surface 18 between two objects.

In some embodiments, the tool 100 may comprise a first lower surface 18 that may be coupled to the nose 19 and to a catch surface 21, preferably so that the nose 19 and catch surface 21 are separated by the first lower surface 18. Generally, a first lower surface 18 may be configured to pry or separate portions of an object, such as a lower hive body 201, away from the lifting surface 13 when the lifting surface 13 and first lower surface 18 of the tool 100 are inserted between two objects, such as a lower hive body 201 and an upper hive body 202. In some embodiments, the first lower surface 18 may be approximately parallel to the handle 11, first upper surface 14, second upper surface 16, and/or second lower surface 22. In further embodiments, the first lower surface 18 may be approximately perpendicular to the first stop surface 15, second stop surface 17 and/or catch surface 21.

Preferably, a first lower surface 18 may be generally flat or planar in shape and/or contour. In preferred embodiments, a first lower surface 18 may comprise a generally planar rectangular prism shape. In alternative embodiments, a first lower surface 18 may be curved, such as by being convex curved or concave curved, or configured with any other contour. In further alternative embodiments, a first lower surface 18 may be circular in shape, triangular in shape, ovoid in shape, or configured with any other shape. In further embodiments, a first lower surface 18 may comprise a sixth length dimension (L6) as shown in FIG. 6, and L6 may be between approximately 0.75 and 2.0 inches, and more preferably between approximately 1.0 and 1.5 inches.

The tool 100 may comprise a catch surface 21 that may be positioned between the first lower surface 18 and the handle 11. In some embodiments, a catch surface 21 may be coupled to the first lower surface 18 and to the second lower surface 22 so that the first lower surface 18 and second lower surface 22 are separated by the catch surface 21. Generally, a catch surface 21 may be configured to rest against interior portions of an object (similar to a barb), such as a lower hive body 201, when one or more surfaces 13, 14, 15, 16, 18, 22, of the tool 100 are inserted between two objects, such as a lower hive body 201 and an upper hive body 202. In some embodiments, the catch surface 21 may be approximately perpendicular to the handle 11, first upper surface 14, second upper surface 16, first lower surface 18, and/or second lower surface 22. In further embodiments, the catch surface 21 may be approximately parallel to the first stop surface 15 and/or second stop surface 17.

Preferably, a catch surface 21 may be generally flat or planar in shape and/or contour. In preferred embodiments, a catch surface 21 may comprise a generally planar rectangular prism shape. In alternative embodiments, a catch surface 21 may be curved, such as by being convex curved or concave curved, or configured with any other contour. In further alternative embodiments, a catch surface 21 may be circular in shape, triangular in shape, ovoid in shape, or configured with any other shape. In further embodiments, a catch surface 21 may comprise a seventh length dimension (L7) as shown in FIG. 7, and L7 may be between approximately 0.05 and 1.0 inches, and more preferably between approximately 0.075 and 0.5 inches.

The tool 100 may comprise a second lower surface 22 that may be positioned between a catch surface 21 and the handle 11. In some embodiments, a second lower surface 22 may be coupled to the catch surface 21 and optionally to a receding surface 23, preferably so that the catch surface 21 and receding surface 23 are separated by the second lower surface 22. Generally, a second lower surface 22 may be configured to pry and/or support portions of an object, such as a lower hive body 201, away from and/or above the lifting surface 13, first upper surface 14, and/or second upper surface 16 when the lifting surface 13, first upper surface 14, and/or second upper surface 16 of the tool 100 are inserted between two objects, such as a lower hive body 201 and an upper hive body 202. In some embodiments, the first lower surface 18 may be approximately parallel to the handle 11, first upper surface 14, second upper surface 16, and/or second lower surface 22. In further embodiments, the first lower surface 18 may be approximately perpendicular to the first stop surface 15, second stop surface 17 and/or catch surface 21.

Preferably, a second lower surface 22 may be generally flat or planar in shape and/or contour. In preferred embodiments, a second lower surface 22 may comprise a generally planar rectangular prism shape. In alternative embodiments, a second lower surface 22 may be curved, such as by being convex curved or concave curved, or configured with any other contour. In further alternative embodiments, a second lower surface 22 may be circular in shape, triangular in shape, ovoid in shape, or configured with any other shape. In further embodiments, a second lower surface 22 may comprise an eighth length dimension (L8) as shown in FIG. 6, and L8 may be between approximately 1.0 and 5.0 inches, and more preferably between approximately 1.75 and 3.0 inches.

The tool 100 may comprise a receding surface 23 that may be positioned between the second lower surface 22 and the handle 11. In some embodiments, a receding surface 23 may be coupled to the second lower surface 22 and preferably to the handle 11, so that the second lower surface 22 and handle 11 may be separated by the receding surface 23. Generally, a receding surface 23 may be configured to pry and/or support portions of an object, such as a lower hive body 201, when the tool 100 is inserted between two objects, such as a lower hive body 201 and an upper hive body 202.

In some embodiments, the receding surface 23 may be angled relative to the handle 11 and/or to one or more other surfaces of the tool 100. In preferred embodiments, a receding surface 23 may be angled relative to the handle axis 28, such as by being angled below the handle axis 28. In further embodiments, a receding surface 23 may be angled relative to the handle axis 28, such as by being angled by approximately 10 to 45 degrees below the handle axis 28. Preferably, a receding surface 23 may be generally flat or planar in shape and/or contour. In preferred embodiments, a receding surface 23 comprise a generally planar rectangular prism shape. In alternative embodiments, a receding surface 23 may be curved, such as by being convex curved or concave curved, or configured with any other contour. In further alternative embodiments, a receding surface 23 may be circular in shape, triangular in shape, ovoid in shape, or configured with any other shape.

In further embodiments, a receding surface 23 may be angled relative to the handle axis 28 by being angled below the handle axis 28 as shown by angle B (FIG. 5). Preferably, Angle B may be between 85 and 15 degrees, and more preferably between 30 and 60 degrees. In further embodiments, a receding surface 23 may comprise a ninth length dimension (L9) as shown in FIG. 6, and L9 may be between approximately 0.75 and 2.0 inches, and more preferably between approximately 1.0 and 1.5 inches.

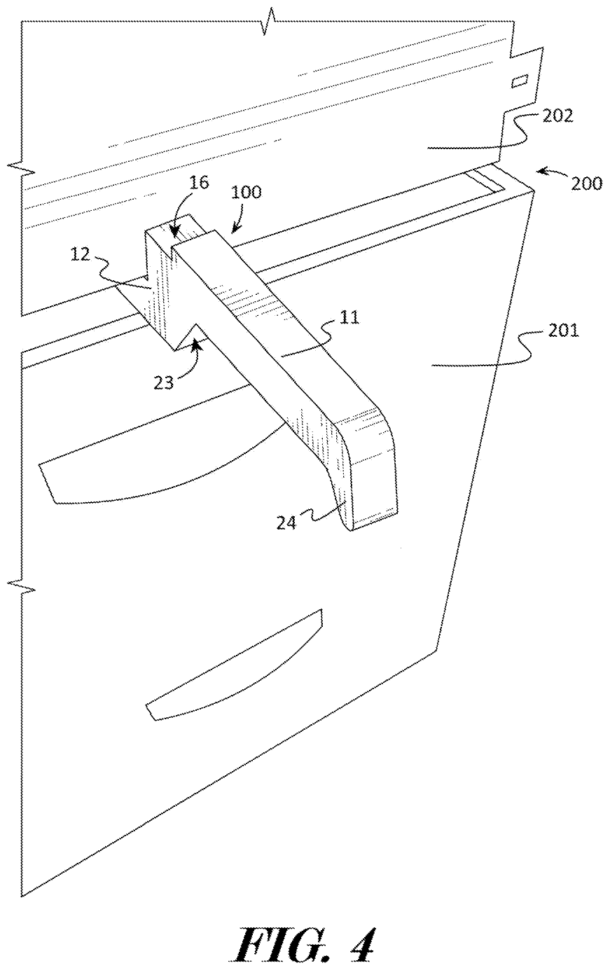

As perhaps best shown in FIG. 4, the hive tool 100 may be used to move and manipulate portions of a bee hive 200, such as a lower hive body 201 and an upper hive body 202. Generally, a user may grip the handle 11 to insert the blade 12 between two adjacent hive bodies or boxes 201, 202, so that the lifting surface 13 and first lower surface 18 may separate the adjacent hive bodies or boxes 201, 202. The blade 12 may be further inserted so that the upper hive body 202 may rest on a desired upper surface 14, 16, while the first lower surface 18 and/or second lower surface 22 may rest on the lower hive body 201 to support the weight of the upper hive body 202 and tool 100, thereby maintaining a separation between the upper hive body 202 and the lower hive body 201 of a bee hive 200. Preferably, a catch surface 21 may rest against interior portions of a lower hive body 201, to prevent the tool 100 from accidentally or inadvertently slipping out from between the lower hive body 201 and an upper hive body 202. Additionally, a lanyard 26 and/or retainer 27 may be used to secure the tool 100 to a user, such as to their clothing, so that the user does not have to worry about the tool 100 falling to an inconvenient position, such as when the user lifts the upper hive body 202 away from or above the lower hive body 201.

In some embodiments, the tool 100 may comprise a blade 41 that may be coupled to a surface, such as to the first lower surface 18. A blade 41 may comprise a blade terminus 42 which may join and separate a blade upper surface 43 and a blade lower surface 44. A blade 41 may be configured in any shape and size. Generally, a blade terminus 42 may extend past the nose 19 so that the blade 41 may function as a narrow, sharp edge to push between hive bodies 201, 202, and other objects. In some embodiments, a blade 41 may be coupled to the first lower surface 18 so that the blade terminus 42 may extend past the nose 19 approximately between 0.01 inches and 5.0 inches.

In preferred embodiments, a blade 41 may comprise a generally planar rectangular shape having a generally flat or planar blade upper surface 43 that is approximately parallel to a generally flat or planar blade lower surface 44. In some embodiments, a blade 41 may be made from or may comprise a metal or metal alloy. A blade 41 may be coupled to a surface of the tool 100, such as to the first lower surface 18, by one or more screws or other threaded fasteners, rivets, adhesive, heat welding, or any other coupling method, including being integrally formed or molded from the same material.

While some exemplary shapes and sizes have been provided for elements of the tool 100, it should be understood to one of ordinary skill in the art that the handle 11, blade 12, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the tool 100 may be made from or may comprise durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the tool 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the tool 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the tool 100 may be coupled by being one of connected to and integrally formed with another element of the tool 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A hive tool for use with a bee hive, the tool comprising:
a. a handle having a handle axis; and
b. a blade coupled to the handle, the blade including:
a lifting surface angled relative to the handle axis;
a nose joining the lifting surface with a first lower surface,
a first upper surface positioned between the lifting surface and a first stop surface;
a second upper surface positioned between the first stop surface and the handle;
a catch surface positioned between the first lower surface and a second lower surface, wherein the second lower surface is positioned between the catch surface and the handle.

2. The device of claim 1, wherein the lifting surface, nose, and first lower surface are each positioned below the handle axis.

3. The device of claim 1, wherein the first lower surface 18 and the second lower surface are each substantially planar in shape, and wherein the first lower surface and the second lower surface are substantially parallel to each other.

4. The device of claim 1, wherein the catch surface comprises a length dimension of between 0.05 and 1.0 inches.

5. The device of claim 1, wherein the first upper surface and the second upper surface are each substantially planar in shape, and wherein first upper surface and the second upper surface are substantially parallel to each other.

6. The device of claim 1, wherein the first stop surface comprises a length dimension of between 0.25 and 1.75 inches.

7. The device of claim 1, wherein the lifting surface is angled below the handle axis by an angle of between 15 and 50 degrees.

8. The device of claim 1, further comprising a receding surface positioned between the second lower surface and the handle.

9. The device of claim 1, further comprising a second stop surface positioned between the second upper surface and the handle.

10. The device of claim 9, wherein the second stop surface and the first stop surface are each substantially planar in shape, and wherein second stop surface and the first stop surface are substantially parallel to each other.

11. The device of claim 1, wherein the first lower surface comprises a length dimension of between 0.75 and 2.0 inches.

12. A hive tool for use with a bee hive, the tool comprising:
a. a handle having a handle axis; and
b. a blade coupled to the handle, the blade including:
a lifting surface angled relative to the handle axis;
a nose joining the lifting surface with a first lower surface,
a first upper surface positioned between the lifting surface and a first stop surface;
a second upper surface positioned between the first stop surface and a second stop surface, the second stop surface positioned between the second upper surface and the handle;
a catch surface positioned between the first lower surface and a second lower surface; and
a receding surface positioned between the second lower surface and the handle.

13. The device of claim 12, wherein the lifting surface, nose, and first lower surface are each positioned below the handle axis.

14. The device of claim 12, wherein the first lower surface and the second lower surface are each substantially planar in shape, and wherein the first lower surface and the second lower surface are substantially parallel to each other.

15. The device of claim 12, wherein the catch surface comprises a length dimension of between 0.05 and 1.0 inches.

16. The device of claim 12, wherein the first upper surface and the second upper surface are each substantially planar in shape, and wherein first upper surface and the second upper surface are substantially parallel to each other.

17. The device of claim 12, wherein the first stop surface comprises a length dimension of between 0.25 and 1.75 inches.

18. The device of claim 12, wherein the lifting surface is angled below the handle axis by an angle of between 15 and 50 degrees.

19. The device of claim 12, wherein the second stop surface and the first stop surface are each substantially planar in shape, and wherein second stop surface and the first stop surface are substantially parallel to each other.

20. The device of claim 12, further comprising a blade coupled to the first lower surface, the bade having a blade terminus that extends past the nose.
